(19) United States
(12) Patent Application Publication
(10) Pub. No.: US 2009/0014998 A1
(43) Pub. Date: Jan. 15, 2009

(54) Method for facilitating return of lost objects and shielding identity of owners

(76) Inventor: Bruce M. Tyrrell, Fort Lauderdale, FL (US)

Correspondence Address: BRINKLE Y, MORGAN, SOLOMON, TATUM, STANLEY, LUNNY,;& CROSBY, LLP, 200 E. LAS OLAS BLVD, SUITE 1900, FORT LAUDERDALE, FL, 33301, US

(21) Appl. No.: 11/827,372

(22) Filed: Jul. 11, 2007

(51) Int. Cl. B42D 15/00

(52) U.S. Cl. 283/70; 283/75

(57) ABSTRACT

The Invention is directed to a system and method for facilitating the retrieval of lost objects and payment of rewards to the finders of lost objects, while protecting the privacy and security of the owner of the lost object.

### FIELD OF THE INVENTION

This Invention relates to services for facilitating the retrieval of lost objects and payment of rewards to the finders of lost objects, in general, and, more specifically, to a method and system which: 1) encourages and facilitates the return by the finder of a lost object to a clearing house in an expeditious manner that protects the privacy and security of an owner of a lost object by shielding the identity of the owner; and 2) facilitates payment of a reward or other consideration by the clearing house to the finders of lost objects, further ensuring the privacy and security of the owner of the lost object.

### BACKGROUND OF THE INVENTION

Systems for facilitating the return of lost objects, in general, have long provided important retrieval services to the owners of lost objects, such as lost keys, wallets, equipment and other items. There are even retrieval systems in existence for retrieval of lost pets, children and the elderly. Also, reward systems for encouraging finders of lost objects to return such objects, in general, have long provided an important catalyst for the return of such lost objects to their rightful owners, associated with a reward paid by the owners.

Retrieval services are akin to personal services and, therefore, there will always be surprisingly new and innovative approaches to providing such services. That is, the quality and utility of such services is personal to the owner of a lost object. One owner of a lost object to the next, in general, will have different priorities and preferences for what makes up a satisfactory retrieval and reward payment service experience. Until now no single lost object retrieval and reward payment program known to the inventor has been proposed which provides the absolute quickest turnaround of a lost object to its owner while maintaining the identity of the owner secret from the finder of the lost object so that the safety and privacy of the owner is not compromised. Therefore, such a system and method is needed.

For example, while some owners will place greater value on a service featuring the expeditious return of lost objects directly from the finder to the owner, other owners will place greater value on maintaining their personal privacy and security. The latter will prefer a personal retrieval service featuring a unique combination of system elements and steps carried out by the retrieval service, including the reward feature, in order to ensure anonymity and personal safety and satisfy their personal preferences respecting the service.

A search has been conducted by the applicant prior to the filing of this application and the following patents are brought the attention of the examiner. From the Inventor's perspective, the issuance of the these referenced patents illustrates how the United States Patent and Trademark Office has long recognized that new and innovative combinations of services for lost object retrieval and reward payment are needed to accommodate the dynamic needs of the public and worthy of letters patent:
1. Thomas, U.S. Pat. No. 4,271,352;
2. Campbell, U.S. Pat. No. 6,546088;
3. Buell, U.S. Pat. No. 5,816,620;
4. Buell, U.S. Pat. No. 6,095,567;
5. Silver, U.S. Pat. No. 6,064,307;
6. Holstrom, U.S. Pat. No. 5,570,081;
7. Bowling, U.S. Pat. No. 6,661,344
8. Phillips, et al, U.S. Pat. No. 5,163,711
9. Fehr, U.S. Pat. No. 5,036,610
10. Sigman, U.S. Pat. No. 4,650,219
11. Hines, U.S. Pat. No. 2,812,601

The present Invention is distinguishable over these patents. For instance, Thomas discloses a method and article for the return of lost items to their rightful owners, and includes a reward system. But, unlike the present Invention, Thomas necessitates the use of an identification card particularly adapted for use with automatic sorting machinery of the kind used for encoding and reading data on plastic cards in banking, credit card and other industries.

Campbell discloses a method and system for the return of lost items to their rightful owners, and includes the automatic entry of the finder into a reward lottery for a predetermined prize, but, unlike the present Invention, Campbell does not disclose payment of a reward by an information center/clearing house to each finder using funds that have been cleared/earmarked or actually secured in escrow in advance by the information center clearing house from the owner. Nor does Campbell disclose an option for payment of the reward directly by the owner to the finder through the use of an automatic debt reward payment arrangement.

Buell discloses a method and article for the return of lost items to their rightful owners, but, unlike the present Invention, requires at least one of a magnetic strip containing owner-specific information, a bar code containing similar information, and a microchip. Also unlike the present Invention, Buell does not disclose the use of a reward associated with the return of the lost object.

Silver discloses a method and article for the return of lost items to their rightful owners, but, unlike the present Invention, does not disclose a pre-paid reward fund or an automatic debit reward payment feature. Nor do any of the claims in Silver involve the use of any reward features.

Holstrom discloses a method and article for the return of lost items to their rightful owners, but, unlike the present Invention, doe not make any reference to a reward system and requires the snapping apart of a two-piece card to provide a tag piece and a base piece, among other things.

Bowling discloses a method and article for the return of lost items to their rightful owners, but, unlike the present Invention, does not disclose the use of any reward features and all of the claims of Bowling require the use, among other things, of a portable recording device and a playback device in a portable or openable identification system.

Phillips discloses a method and article for the return of lost equipment to their rightful owners, but, unlike the present Invention, does not disclose the use of any reward features and all of the claims of Phillips require the use, among other things, of a film bearing an inscription disposed on a rear face of an identification plate that is adhered to a piece of equipment.

Fehr discloses a method and article for the return of lost pets to their rightful owners, but, unlike the present Invention, does not disclose the use of any reward paid by a clearing house to the finder using funds that have been paid in advance by the clearing house from the owner of the lost pet and all of the claims of Fehr require the use, among other things, of pet collars that are dispensed to the owners of pets. Such collars are not disclosed in the present Invention.

Sigman discloses a method and articles for the return of a lost child to their parents, but, unlike the present Invention, does not disclose the use of any reward features. Moreover, Sigman requires the use, among other things, of an identification marking generated from a credit card number of a parent by a formula that permits knowledge of the identification marking to be used to generate enough of the credit card number of the parent to identify him or her.

Hines discloses a method and article for the return of lost keys to their rightful owners, but, unlike the present invention, in the background section of Hines it is indicated that the invention is intended to avoid the use of a third party as an intermediary between the finder and the owner. Instead, the invention in Hines is intended to expedite the return of the lost key back to its owner directly from the finder.

Accordingly, the prior art lacks the element combinations that are present in the Invention disclosed herein. For example, no publicly known lost item retrieval system or methodology exists which incorporates elements of identity protection for the owners of lost objects in the combination and methodology disclosed herein. Combining identity protection elements together in a lost object retrieval and reward payment system and methodology ensures the safety and privacy of lost object owners and is accomplished in the present Invention in a combination heretofore unknown to the art. To further illustrate, where 6,064,307 provides a system and methodology that utilizes a third party clearing house to directly link the finders of lost objects to their owners, the present Invention prevents such direct contact by restricting all contact and identification information accessible to the finder to be that of the third party clearing house, not the owner. This increases the privacy and safety of the owner of lost items by concealing the identity of the owner throughout the lost object recovery process.

In addition, the present Invention offers a new combination of useful features over the prior art which enhances the lost object recovery process by providing unique criteria for the owners, clearing house and finders of the lost property (or their respective agents) on how to use the system and methodology provided by the Invention, providing for the immediate control of the lost object by immediately securing the object and providing the reward in full payment, providing the clearing house and its agents with the authority to recover the object and a source of funds to pay the reward, providing specific timelines and monetary involvement for payment of rewards or replacement of lost items (should the item not be returned in accordance with the timeline), and providing, optionally, discount or reimbursement-type arrangements for replacements when replacement of a lost item is necessary or, optionally, if the lost item is not returned within a predetermined amount of time after it is lost.

A need exists, therefore, for a lost object retrieval and rewards payment system and methodology which shields the identity of the owners of lost objects, provides criteria for the owners of the lost property or their agent on how to use the system and methodology provided by the Invention, provides for the immediate control of the lost object by immediately securing the object and providing the reward in full payment, provides the clearing house and its agents with the authority to recover the object, provides a source of funds to pay the reward, provides specific timelines for payment of rewards, and optionally provides discounts or reimbursement (partial or total) for replacements when replacement of a lost item is deemed necessary (e.g. should the lost item not be returned in accordance with a specified timeline).

### SUMMARY OF THE INVENTION

The present Invention is directed to, in a preferred embodiment, a lost object retrieval system. The lost object retrieval system includes, without limitation, an owner's lost object identification tag which is adapted to be removably affixed to an object, which may disclose such information as a clearing house entity name or other identification indicia thereof, a reward notice, a clearing house contact telephone number or web address, and a unique lost object identification code, for attachment to an object which may become lost. The lost object retrieval system also includes, without limitation, an owner's operation instruction card that features a list of important lost object retrieval process criteria. Such a card might display, among other information and criteria, the name or other identification indicia of the clearing house entity, a service indicator indicative of the nature of the retrieval service, a clearing house telephone contact number, web or e-mail address to facilitate access by owners to owner profiles maintained by the clearing house, clearing house personnel, help and information, a unique lost object identification code matching a unique lost object identification code on the tag, and a list of lost object retrieval safety rules.

The preferred embodiment of the invention is also directed to a method for retrieval of lost objects and payment of rewards, including, without limitation, the steps of: subscribing an owner to the lost object retrieval and rewards payment service of the Invention; securing owner-subscriber profile information in a retrievable, updatable computer database, wherein the profile information further includes owner-subscriber contact information, billing preference, and object information; providing the owner-subscriber with a lost object identification tag to affix to an object to be retrieved if lost, wherein information on the tag provides a finder of the object with notice that a reward is available for the return of the object, the name of or other identification information about the clearing house entity for a finder of the object to use to contact the clearing house, a telephone call-in number, e-mail or website address for the clearing house entity, and a unique object identification code. Once the object is lost, another method provides for the owner to notify the clearing house that the object is lost.

The method also provides at least two ways for the clearing house to respond to the notification by owner, depending on whether a finder finds the lost object and calls the clearing house within a predetermined time (e.g. 48 hours) of the loss. If the finder does call the clearing house within the predetermined time after the object is reported lost, then the method further comprises the steps of the clearing house receiving the lost object from the finder, the clearing house paying the finder a reward, the clearing house debiting the owner's pre-paid account (or the debit or credit card account, depending on the payment preference found in the owner-subscriber profile), and the clearing house returning the object to the owner.

Alternatively, if the finder does not call the clearing house within the predetermined time after the object is reported lost, then an alternative version of the method further comprises the steps of the clearing house paying a portion of the replacement cost of the lost object, and/or the clearing house arranging for replacement cost discounts if available from sellers of replacement objects.

### BRIEF DESCRIPTION OF THE DRAWINGS

FIG. 1 is a top plan view of the tag of this Invention that is adapted to be removably attached to the object to be found if lost.

FIG. 2 is a front view of the owner information and system operation instruction card of this Invention.

FIG. 3 is the back view of the owner information and system operation instruction card of this Invention

FIG. 4 is a flow chart diagram of the preferred methodology used in the Invention.

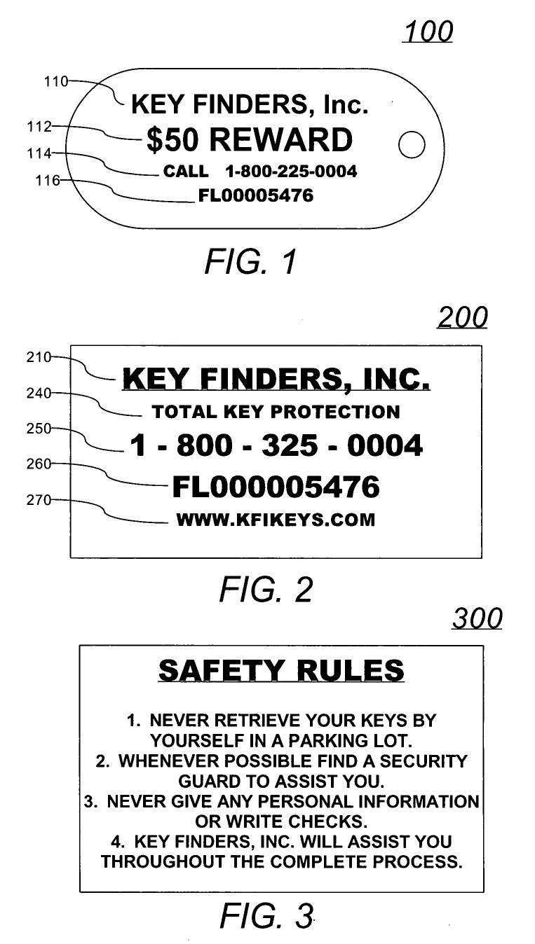

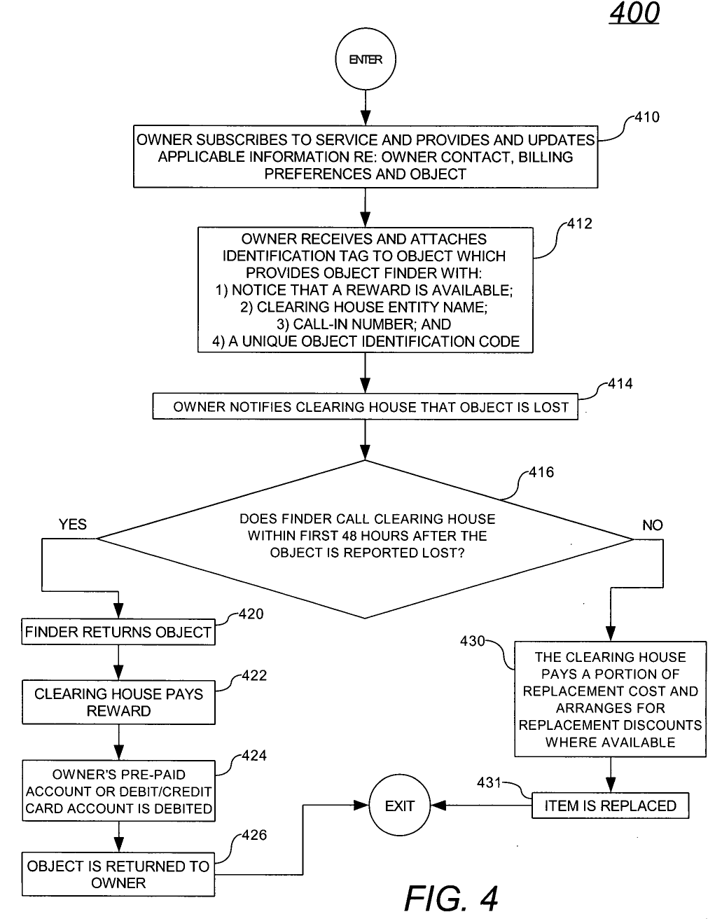

### DETAILED DESCRIPTION

The present Invention is directed to, in a preferred embodiment, a lost object retrieval system, comprising: (1) an owner's lost object identification tag 100 (ideally in the form of, for example, a tag or adhesive-backed sticker) for attachment to an object which may become lost, such tag 100 comprising one or more of: a clearing house entity name or other identification indicia thereof 110, a reward notice 112, a clearing house contact telephone number, e-mail or web address 114, and a unique lost object identification code 116 (ideally comprising an indication of the state, province or territory of the owner); and (2) an owner's operation instruction card 200 (ideally the size of a credit card for easy storage in a purse or wallet) that features a list of important lost object retrieval process criteria, such card 200 further including the name or other identification indicia 210 of the clearing house entity, a service indicator 240 (ideally indicative of the nature of the retrieval service), a clearing house telephone contact number 250 (to facilitate access by owners to owner profiles, clearing house personnel, help and information), a unique lost object identification code 260 which corresponds to (e.g. exactly matching) a unique lost object identification code 116 on tag 100, a clearing house Internet address URL 270 (ideally further providing the owner of the lost object with access to assistance, information and profile management via the Internet), and a list of lost object retrieval safety rules 300.

The shape of the tag 100 may be of any suitable contour, such as a shape which corresponds generally to the object to be protected. The tag 100 may have the indicia 110, 112, 114, and 116 on both sides or on only one side, and may have any other indicia, such a third party advertising for which the clearing house may receive compensation. Conversely, the appearance of the clearing house's identification indicia thereon constitutes free advertising for the clearing house. The tag 100 also defines an aperture used to attach it to the object (such as set of keys). The position of the aperture is such that, when the tag 100 is attached to the object, and the object becomes lost, the front or rear face of the tag 100 will be exposed prominently to anyone who may happen upon it, which increases the likelihood that the object will be found and returned to its owner. The tag 100 can be moved form object to object over time by its owner.

The card 200 displays information which can be used by the owner to log onto the clearing house's website to change owner profile information. In this way, for example, the owner can change the account to a new owner, or change his or her phone or address information, and even change the object to which the tag 100 is attached.

The preferred embodiment of the invention is also directed to a method 400 for retrieval of lost objects and payment of rewards, comprising the steps of: receiving subscription information from an owner of an object to be protected (i.e. the object to which tag 100 will be attached); receiving owner profile information in a retrievable, updatable computer database, wherein the profile information includes owner contact, billing preference, and object information; providing a lost object identification tag to the owner of the object, wherein information on the tag is adapted to provide a finder of the object with one or more of the following: notice that a reward is available for the return of the object, the name of the clearing house entity to contact, a telephone call-in number, e-mail or web address for the clearing house entity, and a unique object identification code. Once the object is lost, the method provides for the owner to notify the clearing house that the object is lost.

The method also provides at least two ways for the clearing house to respond to the notification by owner, depending on whether a finder finds the lost object and calls the clearing house within a predetermined time (e.g. 48 hours) of the loss. If the finder does call the clearing house within the predetermined time after the object is reported lost, then the method further comprises the steps of receiving the object from the finder, paying the finder a reward, billing the owner or debiting the owner's pre-paid account (or the debit credit card account, depending on the payment preference found in the owner-subscriber profile) for the reward amount and any service charge, and returning the object to the owner.

Alternatively, if the finder does not call the clearing house within predetermined time after the object is reported lost, then the method may further comprise one or more of the steps of the clearing house paying/reimbursing a portion of the replacement cost of the lost object, the clearing house arranging for replacement cost discounts if available from sellers of replacement objects, the clearing house refunding all or part of any fee paid by the owner, and/or replacing the lost item. Also alternatively, the owner can elect to be placed into direct contact with the finder to facilitate a quicker return of the object.

The invention permits for the return of lost items within potentially hours. In most instances, when an object that is protected by this invention is lost, only two phone calls need be made. The clearing house can facilitate the return of the lost object by providing a courier package to the finder so that the finder can overnight or otherwise deliver by expedited means the lost object to the clearing house, whereupon the clearing house can then deliver the object to its rightful owner.

In all cases it is to be understood that the above described configurations are merely illustrative of the many possible specific embodiments which represent applications of the present invention. Numerous and varied other configurations can be readily devised in accordance with the principles of the present invention without departing from the spirit and scope of this invention.

What is claimed is:

1. A lost object retrieval system, comprising: an owner's lost object identification tag for attachment to an object which may become lost; and an owner's operation instruction card that features a list of important lost object retrieval process criteria.

2. The lost object retrieval system of claim 1, wherein the identification tag is in the form of a tag adapted to be attached to a key chain.

3. The lost object retrieval system of claim 1, wherein the identification tag is an adhesive-backed sticker.

4. The lost object retrieval system of claim 1, wherein the identification tag further comprises a clearing house entity name, a reward notice, a clearing house contact telephone number, and a unique lost object identification code.

5. The lost object retrieval system of claim 1, wherein the owner's operation instruction card is substantially in the size and shape of a conventional credit card for easy storage in a purse or wallet.

6. The lost object retrieval system of claim 1, wherein the criteria on the owner's operation instruction card includes one or more of: the name of the clearing house entity, an indicator of a service provided by the clearing house, a clearing house telephone contact number, e-mail address of the clearing house, a unique lost object identification code, and a clearing house Internet address URL.

7. A method for retrieval of lost objects and payment of rewards, comprising the steps of: receiving subscriber information from an owner of an object to be protected by a retrieval and reward payment service; receiving owner profile information; providing a lost object identification tag to the owner for attachment to an object; receiving notification from the owner that the object is lost; receiving the object from a finder of the object; paying to the finder a reward; receiving reimbursement from the owner of the reward payment; and furnishing the object to the owner.

8. The method of claim 7, wherein the reimbursing is accomplished by debiting by the clearing house of a pre-paid account, based on a payment preference found in the owner's profile.

9. The method of claim 7, wherein the reimbursing is accomplished by debiting the owner's debit or credit card account, based on a payment preference found in the owner's profile.

10. The method of claim 7, wherein the owner profile information is stored in a retrievable and updatable computer database.

11. The method of claim 7, wherein the owner profile information further comprises owner contact, billing preference, and object information.

12. A method for retrieval of lost objects and payment of rewards, comprising the steps of: subscribing an owner to a lost object retrieval and rewards payment service; securing owner-subscriber profile information; providing a lost object identification tag to the owner for attachment to an object; receiving notification from the owner that the object is lost; paying the owner a portion of the replacement cost of the lost object; arranging by the clearing house for replacement cost discounts if available from sellers of replacement objects; and replacing the item.
